(19) United States
(12) Patent Application Publication
(10) Pub. No.: US 2019/0066245 A1
(43) Pub. Date: Feb. 28, 2019

(54) PERSONALIZED HEALTHCARE IMAGE ANALYSIS SYSTEM

(71) Applicant: INTERNATIONAL BUSINESS MACHINES CORPORATION, Armonk, NY (US)

(72) Inventors: Sun Young Park, San Diego, CA (US); Dustin M. Sargent, San Diego, CA (US)

(21) Appl. No.: 15/804,907

(22) Filed: Nov. 6, 2017

Related U.S. Application Data
(63) Continuation of application No. 15/690,476, filed on Aug. 30, 2017.

(51) Int. Cl. G06Q 50/24; G06F 19/00

(52) U.S. Cl. CPC G06Q 50/24; G06F 19/3431; G06F 19/3487; G06F 19/12; G06F 19/345

(57) ABSTRACT

A computer-implemented method comprising obtaining, by a processor, measurements from a healthcare image of a patient, receiving familial data of the subject of the healthcare image, receiving clinical healthcare data from at least one source, filtering the clinical healthcare data based on the familial data to generate an expected healthcare characteristic pattern, determining, by the processor, whether an estimation equation appropriate for use with the measurements of the patient is preexisting at least partially according to the familial data of the patient and the expected healthcare characteristic pattern, selecting, by the processor, an equation for use with the measurements of the patient to provide an estimation based at least partially on the measurements and the expected healthcare characteristic pattern, determining, by the processor, the estimation at least partially according to the selected equation and the measurements of the patient, and outputting the estimation to a user.

### BACKGROUND

The present disclosure relates to the field of image processing, and more specifically to cognitive computing based image processing for providing healthcare recommendations.

A healthcare image may include a variety of information that may be beneficial in attending to the healthcare of a subject of the healthcare image. Cognitive computing and machine learning may further provide for increased benefit in attending to the healthcare of the subject of the healthcare image by providing insight and analysis of the image to identify potential problems or potential solutions based on data from a potentially large data set of patients.

### SUMMARY

In another embodiment, the present disclosure includes a computer-implemented method comprising obtaining, by a processor, measurements from a healthcare image of a patient, receiving familial data of the subject of the healthcare image, receiving clinical healthcare data from at least one source, filtering the clinical healthcare data based on the familial data to generate an expected healthcare characteristic pattern, determining, by the processor, whether an estimation equation appropriate for use with the measurements of the patient is preexisting at least partially according to the familial data of the patient and the expected healthcare characteristic pattern, selecting, by the processor, an equation for use with the measurements of the patient to provide an estimation based at least partially on the measurements and the expected healthcare characteristic pattern, determining, by the processor, the estimation at least partially according to the selected equation and the measurements of the patient, and outputting the estimation to a user.

### BRIEF DESCRIPTION OF THE DRAWINGS

FIG. 1 depicts a block diagram of a healthcare image analysis system in accordance with various embodiments.

FIG. 2 depicts a flowchart of a personalized healthcare image analysis method in accordance with various embodiments.

FIG. 3 depicts a computing device in accordance with various embodiments.

FIG. 4 depicts a cloud computing environment in accordance with various embodiments.

FIG. 5 depicts abstraction model layers in accordance with various embodiments.

### DETAILED DESCRIPTION

For some health characteristics, analysis of images of a patient may reveal insights into future potential problems. For example, analysis of healthcare images such as a computerized tomography (CT) scan, a x-radiation (x-ray) scan, magnetic resonance imaging (MRI) scan, and/or ultrasound scan may reveal insights into future growth of a patient, future potential health problems of a patient, or other healthcare related characteristics that in some circumstances may then lead to healthcare recommendations. Some of these analyses may be performed by applying known or existing algorithms to data obtained from the images of the patient, for example, such as various measurements. However, these algorithms may have been formed using limited data sets, data sets including patients who are not a particularly good fit to the patient whose images are being analyzed (e.g., because of differences in healthcare needs and inherent characteristics based on geographic location, race, ethnicity, etc.), and/or generalized data that is not personalized to the patient. As such, these algorithms, when used alone, may introduce error into the healthcare characteristics, predictions, and/or recommendations.

Disclosed herein are embodiments that provide for personalized analysis of healthcare images for patients. The personalized analysis may be based, for example, on measurements derived or otherwise taken from the healthcare images. In some embodiments, the analysis may be performed on a single healthcare image of the patient, while in other embodiments multiple healthcare images of the patients may be analyzed. The analysis may be performed, in some embodiments, through the use of one or more data sources. For example, measurements derived or otherwise taken from the healthcare images may be compared to data obtained from one or more previously analyzed healthcare images, through data that has been input (e.g., parental or other familial data such as corresponding or related measurements, demographic information, etc.), and/or using one or more algorithms. In some embodiments, the analysis is personalized to the patient such that the analysis takes into account genetic characteristics of the patient which may cause healthcare needs or recommendations for the patient to vary from what would otherwise exist had the analysis not been personalized. For example, the analysis may account for race, gender, ethnicity, location or region of residence, age, or other such characteristics of the patient or of family members of the patient. In some embodiments, estimations of other health characteristics may be made based on the analysis (e.g., an estimation of weight may be made based on one or more size measurements).

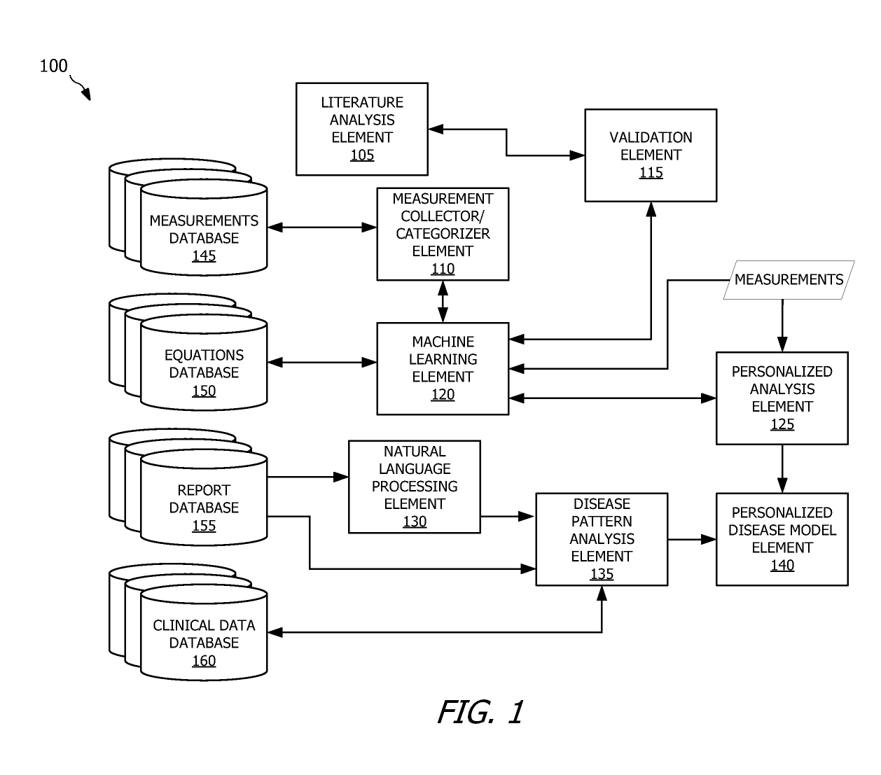

Referring now to FIG. 1, a block diagram of an embodiment of a healthcare image analysis system 100 is shown. The system 100 may be implemented on a mobile electronic device, a computer, a server, or in a cloud-computing environment. As such, the various elements of the system 100 may be commonly located (e.g., on a single computing device), or alternatively may be distributed across a plurality of computing devices or nodes (e.g., such as cloud-computing nodes).

In some embodiments, the system 100 comprises a literature analysis element 105, a measurement collector/categorizer element 110, a validation element 115, a machine learning element 120 (which in some embodiments may also be referred to as a pattern analysis element and/or a regression or regression analysis element), a personalized analysis element 125, a natural language processing element 130, a disease pattern analysis element 135, and a personalized disease model element 140. The system 100 may further comprise or be coupled to one or more measurements databases 145, equations databases 150, report databases 155, and/or clinical data databases 160. Each of the elements of the system 100 may be separate from other elements of the system 100, or one or more of the elements may be combined or implemented together. Any one or more of the elements of the system 100 may be implemented as software or a software module, for example as code and/or instructions stored in a memory and configured to be executed by a processor. In this way, a processor may be configured to implement and/or execute any one or more of the elements of the system 100. Furthermore, any one or more of the elements of the system 100 may be implemented in hardware, for example, as digital logic, an application specific integrated circuit (ASIC), or as any other suitable form of hardware device.

When the system 100 receives measurements from a healthcare image, the system 100 may perform an evaluation to determine whether a data set or equation for processing the measurements is preexisting, for example, from previously acquired measurements and/or from medical publications such as journal articles, textbooks, etc. The evaluation may be performed, for example, by the machine learning element 120. In some embodiments, the measurements may be input manually by a healthcare professional, while in other embodiments the measurements may be taken automatically by the system 100 through processing of the healthcare image (e.g., such as image recognition). In yet other embodiments, the measurements may be provided to the system 100 by another system, such as an imaging system which captured the healthcare image and provides an estimate of measurements of elements located within the healthcare image.

In some embodiments, the machine learning element 120 performs the evaluation to determine whether the data set or equation for processing the measurements is preexisting by comparing familial data of the subject of the healthcare image to data associated with the data set or equations. For example, the machine learning element 120 may receive as input, various characteristics or healthcare data of family members (e.g., such as mother, father, brother, sister, grandmother, grandfather, aunt, uncle, etc.) of the subject of the healthcare image. The input (generally termed as familial data) may be input manually (e.g., by a user entering the input via a keyboard, mouse, microphone, camera, touchscreen, or other input device), or may be input automatically (e.g., by the system 100 retrieving the input from an external location at which the input is stored and/or the system 100 performing natural language processing on a scanned image, such as a questionnaire, containing the input). The characteristics or healthcare data may be used by the machine learning element 120 to determine an appropriate data set or equation for use in analyzing the healthcare image to form estimations or recommendations.

For example, a data set or equation generated using a population sample living in a particular region may vary from a data set or equation generated using a population sample living in a different region. These variations may result from, for example, differences in climate, differences in regional diet, differences in a predominant race or ethnicity living in the respective regions, or other similar criteria. The variations may result in one of the data sets or equations being more suitable for use in analyzing the healthcare image to form estimations or recommendations than the other data set or equation. For example, when an individual visits a healthcare professional in the first region, the healthcare professional may automatically use a data set or equation associated with the first region. However, if the individual has only recently moved to the first region from the second region, or has significant ties such as racial or ethnic to the second region, the data set or equation associated with the second region may be more appropriate and may provide more meaningful information to the healthcare professional and/or the individual. The machine learning element 120 may also receive clinical healthcare data from one or more sources. The clinical healthcare data may be, for example, previously observed and anonymized data from other patients, medical research, or other forms of clinical data.

The machine learning element 120 may, for example, filter the clinical healthcare data based on the familial data to generate an expected healthcare characteristic pattern. For example, the machine learning element 120 may filter the clinical healthcare data based on the familial data to generate an expected male healthcare characteristic pattern based at least partially on male familial data. The machine learning element 120 may further filter the clinical healthcare data based on the familial data to generate an expected female healthcare characteristic pattern based at least partially on female familial data. The machine learning element 120 may then combine the expected male healthcare characteristic pattern and the expected female healthcare characteristic pattern to generate the expected healthcare characteristic pattern.

When a data set or equation for processing the measurements is preexisting, the machine learning element 120 may access the equation from an equations database 150 and/or from a source outside of the system 100, for example, via the literature analysis element 105. The literature analysis element 105 may perform image recognition and/or natural language processing to obtain the data set or equation from the outside source and provide the data set or equation to the machine learning element 120. When a data set or equation for processing the measurements is not preexisting, the machine learning element 120 may derive a new equation. The new equation may be based on one or more preexisting equations (e.g., as stored in an equations database 150 and/or published in literature analyzed by the literature analysis element 105), one or more data sets (e.g., such as data sets obtained during medical research), measurements, anonymized patient characteristics, and/or estimations from previous healthcare image analyses, familiar data, or other similar information. For example, the newly derived equation may be derived, at least in part, according to measurements collected by the measurement collector/categorizer element 110 from a measurements database 145, for example, such as measurements and corresponding estimations or recommendations from previously analyzed healthcare images of subjects substantially related to the subject of the healthcare image being analyzed by the system 100. The newly derived equation may be compared against known data (e.g., other equations, data sets, or medical research such as appearing in journals or other digital or physical media) by the validation element 115 to validate results obtained using the newly derived equation as being within an expected or acceptable range of results obtained using preexisting data sets or equations. The newly derived equation, in some embodiments, may be stored to an equations database 150 for later use by the system 100.

The machine learning element 120 may send the equation (whether a preexisting equation or a newly derived equation) to the personalized analysis element 125. The personalized analysis element 125 may perform an analysis of the healthcare image (e.g., such as using measurements obtained from the healthcare image automatically by the system 100 or entered into the system 100 manually by the healthcare provider or other person) according to the equation received from the machine learning element 120. In at least some embodiments, the personalized analysis element 125 may determine one or more estimations according to the healthcare image (e.g., the measurements from the healthcare image) and/or the equation received from the machine learning element 120. For example, in at least some embodiments, the personalized analysis element 125 may determine an estimated weight and/or estimated growth size (such as an estimated or expected size after passage of a given amount of time from the time of the determination) based on at least some measurements of distance taken from the healthcare image. In other embodiments, the personalized analysis element 125 may determine a percentile ranking according to the measurements and/or the one or more estimations and/or may provide a comparison between the measurements and/or the one or more estimations and other data, such as expected measurements and/or estimation, previous measurements and/or estimation from a prior healthcare image analysis, etc. In some embodiments, the personalized analysis element 125 may further determine the one or more estimations according to the familial data received by the system 100. For example, the personalized analysis element 125 may assign certain factors of the equation a greater or lesser weight during determination of the one or more estimations at least partially based on, or according to, the familial data received by the system 100.

In some embodiments, the estimations and the measurements may be stored to a measurements database 145 for use in subsequent healthcare image analyses, for example, in deriving new equations as discussed above. The estimations and measurements may be anonymized to protect the privacy of the patient depicted in the healthcare image and may be stored subsequent to receiving authorization from the patient and/or an authorized representative of the patient authorized by the patient or by law to make medical related decisions on behalf of the patient. In some embodiments, the estimations may be output to a user of the system 100. For example, the estimations may displayed on an electronic display, printed (and/or a printer may be instructed to print the estimation on physical media), communicated to the user via electronic messaging, and/or any other suitable form of output. The user may be, for example, a healthcare professional (doctor, nurse, physician's assistant, etc.), the patient depicted in the healthcare image (or subject of the healthcare image), an authorized representative of the patient depicted in the healthcare image (or subject of the healthcare image), or any other suitable authorized person or persons.

The estimations may be provided to the personalized disease model element 140 for further estimations, predictions, and/or healthcare recommendations. For example, the personalized disease model element 140 may determine and provide further estimation, predictions, and/or healthcare recommendations such as risks for certain diseases or health problems, recommendations for treatment or intervention to correct characteristics which are identified through the measurements, estimations, and/or healthcare professional observations as potentially problematic or less than ideal, and/or other such estimations, predictions, and/or healthcare recommendations.

In some embodiments, observations of healthcare professionals for the patient may be stored in one or more report databases 155. The observations may be, for example, data input into an electronic document or form, scanned documents, other healthcare images with annotations, etc. The observations may be structured (e.g., such as in the case of electronic documents or forms in which a particular observation may include an association to a certain category of information and may be in a computer-readable format), or the observations may be unstructured (e.g., such as in the case of scanned documents or annotations on healthcare images). When the observations are in the unstructured format, the observations may be processed by the natural language processing element 130 to determine an intent and/or meaning of the observations. The outputs of the natural language processing element 130, or the structured observations from a report database 155, may then be processed by the disease pattern analysis element 135. The disease pattern analysis element 135, in some embodiments, analyzes the outputs of the natural language processing element 130 and/or the structured observations from a report database 155 to determine whether the observations, taken alone or in combination with one or more of the measurements received by the system 100 and/or the estimations formulated by the personalized analysis element 125, are indicative and/or suggestive of a disease or other healthcare problem.

In some embodiments, the disease pattern analysis element 135 may be a machine learning element capable of processing and learning from data. In some embodiments, the disease pattern analysis element 135 may be communicatively coupled to a clinical data database 160 that may include information associating certain observations, measurements, and or estimations with certain diseases or health problems. In some embodiments, the information may be a result of medical research, information published in medical journals, or information obtained through follow-up with patients for who healthcare image analysis by the system 100 was previously performed. For example, patients may be surveyed one or more times subsequent to healthcare image analysis being performed by the system 100 to determine whether estimation, predictions, and or recommendations of the system 100 were accurate, precise, helpful, or otherwise beneficial to the patient. The resulting information from these surveys may be used to train the system 100 (e.g., via the machine learning element 120 and/or the disease pattern analysis element 135) to improve estimations, predictions, and/or recommendations of other patients for whom healthcare image analysis is subsequently performed.

The personalized disease model element 140 may receive the output of the disease pattern analysis element 135 indicating whether measurements, estimations, or observations for a patient are indicative of a disease or healthcare problem and may generate and provide the further estimation, predictions, and/or healthcare recommendations to the patient. In some embodiments, the personalized disease model element 140 may additionally receive the familial data of the patient, the measurements received by the system 100, and/or the estimations formulated by the personalized analysis element 125 and use the additional data in generating and providing (e.g., as output) the further estimation, predictions, and/or healthcare recommendations to the patient.

In some embodiments, the system 100 may be a personalized obstetrics analysis system. The personalized obstetrics analysis system may receive an ultrasound image of a fetus and determine measurements of the fetus (e.g., abdominal circumference, biparietal diameter, crown-rump length, head circumference, femur length, or other such measurements) or other data from the ultrasound image. In other embodiments, the measurements may be input into the personalized obstetrics analysis system manually or otherwise received from another device which determines the measurements. The personalized obstetrics analysis system may determine whether a similar fetus group exists (e.g., such as based on parental race, ethnicity, predominant region of living, etc.) and is associated with a preexisting equation (e.g., such as based on a regression equation and table from existing medical literature) for determining estimations according to the measurements. The equation may be preexisting, for example, through prior medical research, prior healthcare image analyses, or other similar means. When the equation is preexisting, the equation may be used by the personalized obstetrics analysis system to determine estimations related to the fetus (e.g., such as estimated age, estimated weight, growth percentile, comparisons, etc.). In some embodiments, multiple preexisting equations may be identified and a best preexisting equation from among the multiple equations may be identified and used. In some embodiments, the preexisting equation may be augmented according to familiar data such as of the mother carrying the fetus, the mother's sister, the mother's mother, the mother's husband, etc. to provide personalization that accounts for genetic traits or tendencies that may vary from those of a sample group relied upon during formation of the preexisting equation.

When the equation is not preexisting, the personalized obstetrics analysis system may derive a new equation for determining the estimations. The new equation may be based, at least partially, on any one or more of familial data of the fetus, preexisting equations, data sets from which preexisting equations were formed, previously obtained and stored data (e.g., such as measurements and their associated familial data and/or estimations) from prior healthcare image analyses, or medical literature or research. The newly derived equation may be stored by the personalized obstetrics analysis system for subsequent use in future healthcare image analyses (e.g., as a preexisting equation, as discussed above). After deriving the newly derived equation, the personalized obstetrics analysis system may use the newly derived equation to determine estimations in a manner substantially similar to that described above with respect to preexisting equations. In some embodiments, the personalized obstetrics analysis system further generates and provides healthcare predictions or recommendations, for example, according to healthcare professional observations in a manner substantially similar to that described above.

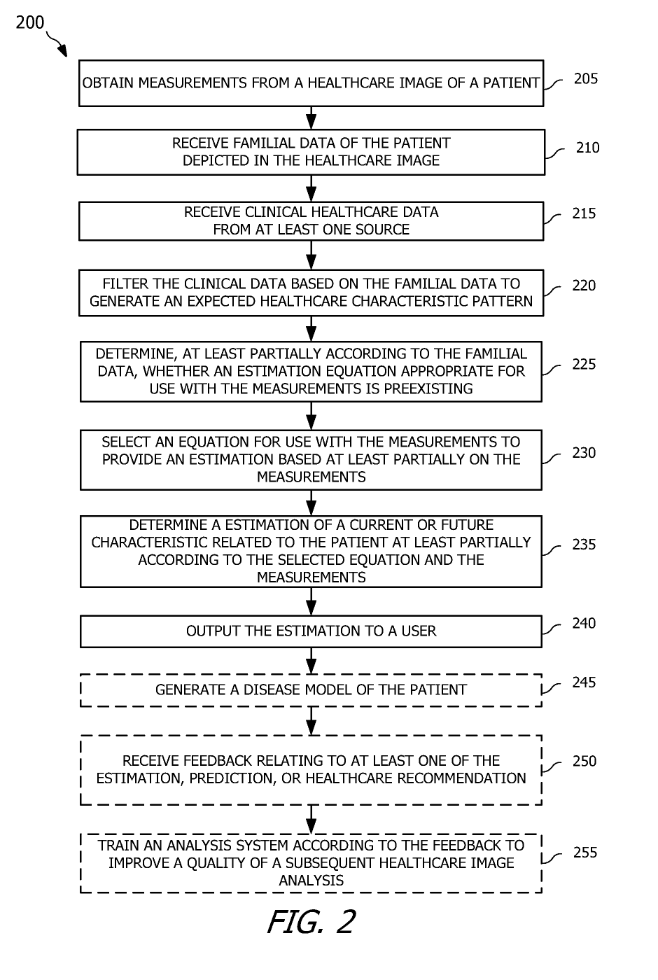

Turning now to FIG. 2, a flowchart of an embodiment of a personalized healthcare image analysis method 200 is shown. The method 200 may be performed by a system or apparatus, such as the system 100, described above with respect to FIG. 1, to analyze a healthcare image and provide any one or more of estimations, predictions, or recommendations at least partially according to a content of the healthcare image. For example, any one or more operations of the method 200 may be performed by a processor implementing any one or more of the elements of the system 100 of FIG. 1, such as, for example, the machine learning element 120, personalized analysis element 125, disease pattern analysis element 135, personalized disease model element 140, and/or other various elements of the system 100. In various embodiments, the healthcare image analysis may provide an estimate age, an estimated weight, a risk for a disease or other healthcare problem, or other form of estimation, prediction, or healthcare recommendation.

At operation 205, measurements from a healthcare image (e.g., of a patient) are obtained. In some embodiments, the measurements are received as data input manually or determined by another system. In other embodiments, the measurements may be obtained through image analysis of the healthcare image. The measurements may be, for example, measurements such as length, diameter, circumference, or other similar measurements from body parts illustrated in the healthcare image (e.g., of body parts of a subject of the healthcare image). At operation 210, familial data of the patient depicted in the healthcare image is received (and/or obtained). The familial data may be received, for example, from a database or other form of electronic data store, from an interactive form in which the familial data was input, from an image analysis and/or natural language processing of a scanned information form, and/or any other suitable location. At operation 215, clinical healthcare data is received (and/or obtained) from at least one source. The clinical healthcare data may be received, for example, from a database or other form of electronic data store, from image analysis and/or natural language processing of data sources such as medical research journals, and/or any other suitable location.

At operation 220, the clinical healthcare data is filtered based on the familial data to generate an expected healthcare characteristic pattern. For example, the clinical healthcare data may be filtered based on male familial data of the patient depicted in the healthcare image and based on female familial data of the patient depicted in the healthcare image. The filtering may result in an expected male healthcare characteristic pattern and an expected female healthcare characteristic pattern, respectively. The expected male healthcare characteristic pattern and the expected female healthcare characteristic pattern may be combined to generate the expected healthcare characteristic pattern. The expected healthcare characteristic pattern may, for example, indicate a present or future expected healthcare characteristic of the patient depicted in the healthcare image based on familial data and the resulting expected male healthcare characteristic pattern and the expected female healthcare characteristic pattern.

At operation 225, the received familial data is at least partially used to determine whether estimation equations appropriate for use with the measurements of the patient are preexisting. The familial data may be, for example, race, ethnicity, age, weight, medical history, predominant geographic area of residency, or other such characteristics of a horizontal sibling (e.g., brother or sister), vertical sibling (e.g., child, parent, grandparent, etc.) or any other suitable family member.

At operation 230, an equation is selected for use with the measurements of the patient to provide an estimation based at least partially on the measurements. In some embodiments, the equation may be, for example, the preexisting equation identified at operation 225. In other embodiments, such as when a preexisting equation is not identified at operation 225, the equation may be newly derived equation based, at least in part, on any one or more of preexisting equations, medical research or journal articles, and/or the familial data. The newly derived equation may be generated, for example, by a machine learning element that at least partially personalizes the equation to the patient (e.g., such as with respect to characteristics of race, ethnicity, predominant geographic area of residency, familial medical history, etc.).

At operation 235, an estimation of a current or future characteristic related to the patient is determined at least partially according to the equation selected at operation 230 and the measurements obtained at operation 205. The estimation may be, for example, an estimated weight, and estimated age, or a projected size (e.g., such as height). In some embodiments, the estimation may be further determined at least partially according to the familial data of the patient. At operation 240, the estimation is output to a user. The estimation may be output to the user by, for example, displaying the estimation on an electronic display, printing and/or instructing a printer to print the estimation on physical media, communicating the estimation to the user via electronic messaging, and/or any other suitable form of output. The user may be, for example, a healthcare professional (doctor, nurse, physician's assistant, etc.), the patient depicted in the healthcare image, an authorized representative of the patient depicted in the healthcare image, or any other suitable authorized person or persons.

In some embodiments, the method 200 may further include operation 245. At operation 245, a disease model of the patient may be generated. Generating the disease model, in various embodiments, may include performing natural language processing on healthcare professional observations of the patient and performing machine learning processing on the healthcare professional observations to determine potential indicators of present or future disease or other health problems. Generating the disease model may also include analyzing any one or more of the measurements, estimations, and/or familial data to generate the disease model. The disease model, in various embodiments, may provide for predictions (e.g., such as of a risk for future disease or other health problems) and/or healthcare recommendations (e.g., remedial measures, intervention steps, treatment, or other similar recommendations) to cure, minimize and effect on, or otherwise mitigate the risk of, or the actual, disease or other healthcare problem.

In some embodiments, the method 200 may optionally include operation 250. Operation 250 may include receiving feedback relating to an accuracy, precision, or helpfulness of the estimations, predictions, and/or healthcare recommendations. The feedback may be received, for example, in response to surveys answered by the patient and/or an authorized representative of the patient. The feedback may be, in some embodiments, used at operation 255 to train an analysis system (e.g., the system 100) to improve the quality (e.g., accuracy, precision, and/or helpfulness) of subsequent analyses, estimations, predictions, and/or healthcare recommendations provided by the analysis system implementing the method 200.

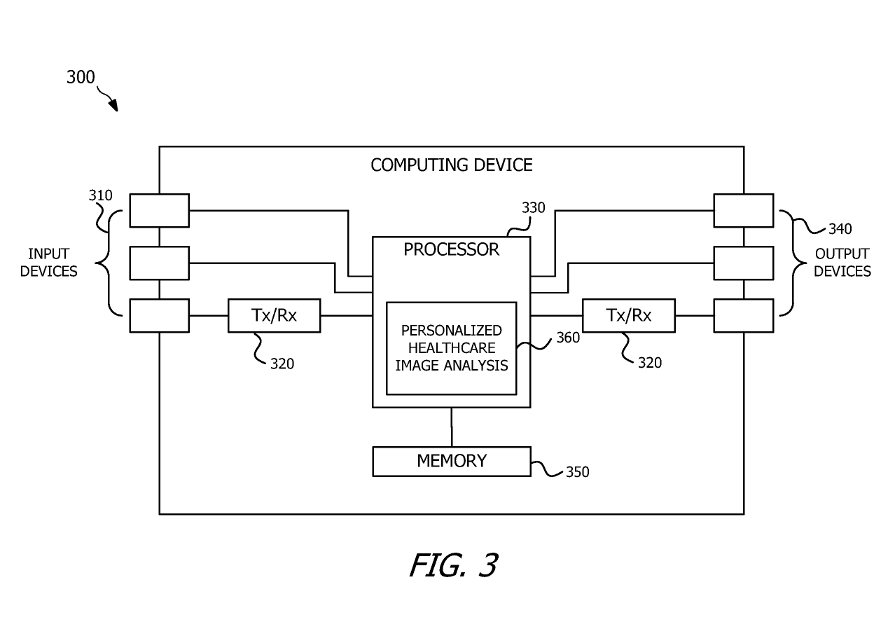

With reference now to FIG. 3, a schematic diagram of a computing device 300 according to various embodiments is shown. Computing device 300 may be any suitable processing device capable of performing the functions disclosed herein such as a computer system, a server, a cloud computing node, a cognitive computing system, or may be generally representative of a distributed computing device in which one or more components of computing device 300 are distributed or shared across one or more devices. Computing device 300 is configured to implement at least some of the features/methods disclosed herein, for example, the personalized healthcare image analysis, such as described above with respect to system 100 and/or method 200. For example, the computing device 300 may be, or may implement, any one or more of the literature analysis element 105, measurement collector/categorizer element 110, validation element 115, machine learning element 120, personalized analysis element 125, natural language processing element 130, disease pattern analysis element 135, and/or personalized disease model element 140. In various embodiments, for instance, the features/methods of this disclosure are implemented using hardware, firmware, and/or software (e.g., such as software modules) installed to run on hardware.

Computing device 300 is a device (e.g., a computer system, a user equipment, a network device, a server, a cloud computing node, an automated assistant, a robotic system, etc.) that receives measurements from a healthcare image and, according to preexisting or newly derived equations, determines estimations, predictions, and/or healthcare recommendations based at least partially on the measurements and/or familial data of a subject of the healthcare image. The computing device 300 may be an all-in-one device that performs each of the aforementioned operations, or the computing device may be a node that performs any one or more, or portion of one or more, of the aforementioned operations. In one embodiment, the computing device 300 is an apparatus and/or system configured to provide personalized healthcare image analysis as described with respect to system 100 and/or method 200, for example, according to a computer program product executed on, or by, at least one processor.

The computing device 300 comprises one or more input devices 310. Some of the input devices 310 may be microphones, keyboards, touchscreens, buttons, toggle switches, cameras, and/or other devices that allow a user to interact with, and provide input to, the computing device 300. Some other of the input devices 310 may be downstream ports coupled to a transceiver (Tx/Rx) 320, which are transmitters, receivers, or combinations thereof. The Tx/Rx 320 transmits and/or receives data to and/or from other computing devices via at least some of the input devices 310. Similarly, the computing device 300 comprises a plurality of output devices 340. Some of the output devices 340 may be speakers, a display screen (which may also be an input device such as a touchscreen), lights, or any other device that allows a user to interact with, and receive output from, the computing device 300. At least some of the output devices 340 may be upstream ports coupled to another Tx/Rx 320, wherein the Tx/Rx 320 transmits and/or receives data from other nodes via the upstream ports. The downstream ports and/or the upstream ports may include electrical and/or optical transmitting and/or receiving components. In another embodiment, the computing device 300 comprises one or more antennas (not shown) coupled to the Tx/Rx 320. The Tx/Rx 320 transmits and/or receives data from other computing or storage devices wirelessly via the one or more antennas.

A processor 330 is coupled to the Tx/Rx 320 and at least some of the input devices 310 and/or output devices 340 and is configured to implement personalized healthcare image analysis. In an embodiment, the processor 330 comprises one or more multi-core processors and/or memory modules 350, which functions as data stores, buffers, etc. The processor 330 is implemented as a general processor or as part of one or more application specific integrated circuits (ASICs), field-programmable gate arrays (FPGAs), and/or digital signal processors (DSPs). Although illustrated as a single processor, the processor 330 is not so limited and alternatively comprises multiple processors. The processor 330 further comprises processing logic configured to execute a personalized healthcare image analysis computer program product 360 that is configured to implement personalized healthcare image analysis as described with respect to system 100 and/or method 200, discussed above.

FIG. 3 also illustrates that a memory module 350 is coupled to the processor 330 and is a non-transitory medium configured to store various types of data. Memory module 350 comprises memory devices including secondary storage, read-only memory (ROM), and random access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage is used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 350 may be used to house the instructions for carrying out the various embodiments described herein. For example, the memory module 350 may comprise the personalized healthcare image analysis computer program product 360, which is executed by processor 330.

It is understood that by programming and/or loading executable instructions onto the computing device 300, at least one of the processor 330 and/or the memory module 350 are changed, transforming the computing device 300 in part into a particular machine or apparatus, for example, a personalized healthcare image analysis system having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and will be produced in large volume may be preferred to be implemented in hardware (e.g., in an ASIC) because for large production runs the hardware implementation may be less expensive than software implementations. Often a design may be developed and tested in a software form and then later transformed, by design rules well-known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, procedural programming languages, such as the “C” programming language, and functional programming languages such as Haskell or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider (ISP)). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

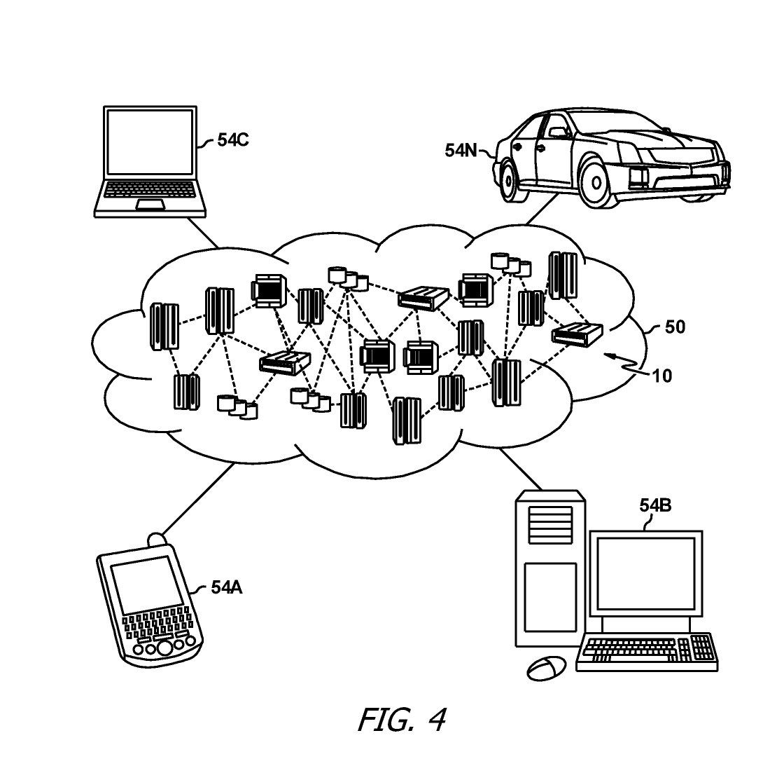

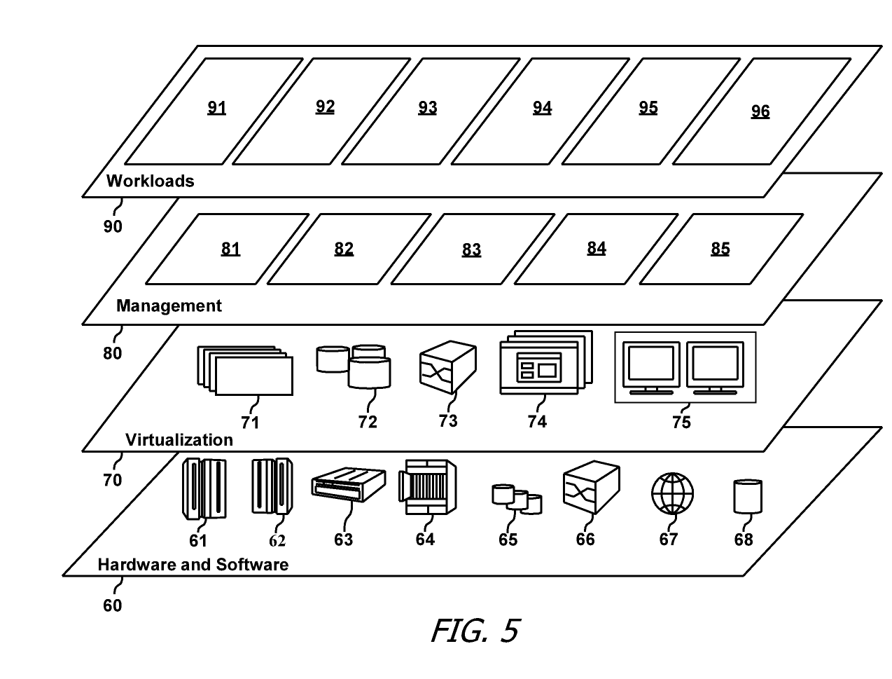

Turning now to FIGS. 4 and 5, it is to be understood that although this disclosure includes a detailed description related to cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

The cloud model characteristics may include on-demand self-service, broad network access, resource pooling, rapid elasticity, and/or measured service. On-demand self-service is a characteristic in which a cloud consumer can unilaterally provision computing capabilities, such as server time and network storage, as needed automatically without requiring human interaction with the service's provider. Broad network access is a characteristic in which capabilities are available over a network and accessed through standard mechanisms that promote use by heterogeneous thin or thick client platforms (e.g., mobile phones, laptops, and personal digital assistants (PDAs)). Resource pooling is a characteristic in which the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity is a characteristic in which capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service is a characteristic in which cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The cloud model Service Models may include Software as a Service (SaaS), Platform as a Service (PaaS), and/or Infrastructure as a Service (IaaS).

SaaS is a service model in which the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. PaaS is a service model in which the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. IaaS is a service model in which the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

The cloud model Deployment Models may include private cloud, community cloud, public cloud, and/or hybrid cloud. Private cloud is a deployment model in which the cloud infrastructure is operated solely for an organization. It may be managed by the organization or a third party and may exist on-premises or off-premises. Community cloud is a deployment model in which the cloud infrastructure is shared by several organizations and supports a specific community that has shared concerns (e.g., mission, security requirements, policy, and compliance considerations). It may be managed by the organizations or a third party and may exist on-premises or off-premises. Public cloud is a deployment model in which the cloud infrastructure is made available to the general public or a large industry group and is owned by an organization selling cloud services. Hybrid cloud is a deployment model in which the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, PDA or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that cloud computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. The hardware and software components of hardware and software layer 60 may serve as the underlying computing components on which cloud computing functions are executed in response to receipt of a request for performance of a function and/or service offered as a part of cloud computing environment 50 such as, for example, the speculative processing described above.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. These virtual entities may enable a subscriber to cloud computing environment 50 to interact indirectly with the hardware and software components of hardware and software layer 60 indirectly via virtual layer 70 without having a specific knowledge of, or interacting directly with, hardware and software layer 60. For example, a plurality of subscribers may interact with virtualization layer 70 to respectively access a corresponding plurality of virtual servers 71 and virtual storage 72 that all exist as separate threads, instances, partitions, etc. on a single server 62 and storage device 65, respectively. In such a scenario, virtualization layer 70 may cause each virtual server 71 and virtual storage 72 to appear to each subscriber as a dedicated and seamless computing and storage device, while enabling efficient operation of the hardware and software components of hardware and software layer 60 by reducing a potential for redundancy of components.

In one example, management layer 80 may provide the functions described below via an abstraction layer such that a subscriber to cloud computing environment 50 may interact with virtualization layer 70 and/or hardware and software layer 60 indirectly via management layer 80 without having a specific knowledge of, or interacting directly with, virtualization layer 70 and/or hardware and software layer 60. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA. Management layer 80 enables a subscriber to cloud computing environment 50 to interact with cloud computing environment 50 through management layer 80 to perform tasks and functions (e.g., administrative tasks) separate from actual execution of functions in the cloud computing environment 50. For example, an administrator may request access to a certain amount of computing resources (e.g., as provided in virtualization layer 70 and/or hardware and software layer 60) in cloud computing environment 50 via management layer 80 without having a specific knowledge of, or interacting directly with, virtualization layer 70 and/or hardware and software layer 60.

Workloads layer 90 provides examples of functionality for which the cloud computing environment may be utilized. The workloads and functions illustrated in workloads layer 90 are merely exemplary workloads and functions that may be executed in cloud computing environment 50 at the request or direction of a subscriber to cloud computing environment 50, and are not limited to those explicitly recited herein. Examples of workloads and functions which may be provided from this layer include: mapping and navigation 91; software development and lifecycle management 92; virtual classroom education delivery 93; data analytics processing 94; transaction processing 95; and personalized healthcare image analysis 96. These workloads and functions of workloads layer 90 may be end-user applications that enable a subscriber to cloud computing environment 50 to interact with any of management layer 80, virtualization layer 70, and/or hardware and software layer 60 indirectly via workloads layer 90 without having a specific knowledge of, or interacting directly with, any of management layer 80, virtualization layer 70, and/or hardware and software layer 60. In this manner, the subscriber and/or an end user who accesses cloud computing environment 50 may not require any form of specialized knowledge relating to the composition or operation of any of management layer 80, virtualization layer 70, and/or hardware and software layer 60 to perform the workloads and functions of workloads layer 90. In such a scenario, the workloads and functions of workloads layer 90 are said to be abstracted from management layer 80, virtualization layer 70, and hardware and software layer 60 because workloads layer 90 hides the underlying operation of management layer 80, virtualization layer 70, and hardware and software layer 60 from the subscriber and/or end-user while still enabling the subscriber and/or end-user to indirectly interact with management layer 80, virtualization layer 70, and/or hardware and software layer 60 to receive the computer processing benefits thereof via workloads layer 90.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other intervening devices and/or connections. Unless otherwise stated, “about,” “approximately,” or “substantially” preceding a value means +/−10 percent of the stated value or reference.

What is claimed is:

1. A computer-implemented method comprising:
obtaining, by a processor, measurements from a healthcare image of a patient;
receiving familial data of the patient depicted in the healthcare image;
receiving clinical healthcare data from at least one source;
filtering the clinical healthcare data based on the familial data to generate an expected healthcare characteristic pattern;
determining, by the processor, whether an estimation equation appropriate for use with the measurements of the patient is preexisting at least partially according to the familial data of the patient and the expected healthcare characteristic pattern;
selecting, by the processor, an equation for use with the measurements of the patient to provide an estimation based at least partially on the measurements and the expected healthcare characteristic pattern;
determining, by the processor, the estimation at least partially according to the selected equation and the measurements of the patient; and
outputting the estimation to a user.

2. The computer-implemented method of claim 1, wherein the estimation is of a current or future health characteristic of the patient.

3. The computer-implemented method of claim 1, wherein the estimation is further based on the familial data of the patient.

4. The computer-implemented method of claim 1, wherein selecting the equation for use with the measurements of the patient comprises selecting a preexisting equation when the estimation equation appropriate for use with the measurements of the patient is preexisting.

5. The computer-implemented method of claim 1, wherein selecting the equation for use with the measurements of the patient comprises deriving a personalized equation for estimation when the estimation equation appropriate for use with the measurements of the patient is not preexisting, and wherein the personalized equation is based at least partially on medical research, other preexisting equations, and the familial data of the patient.

6. The computer-implemented method of claim 1, further comprising generating a disease model of the patient depicted in the healthcare image, wherein the disease model provides at least one or more predictions of risks of a health problem or healthcare recommendations, and wherein generating the disease model comprises:
performing natural language processing on healthcare professional observations of the patient;
performing machine learning processing on the healthcare professional observations to determine potential indicators of health problems; and
analyzing the measurements, estimations, and familial data to generate the disease model.

7. The computer-implemented method of claim 6, further comprising:
receiving feedback relating to at last one of the estimation, prediction, or healthcare recommendation; and
training an analysis system according to the feedback to improve a quality of subsequent analyses of healthcare images.
